(19) United States
(12) Patent Application Publication
(10) Pub. No.: US 2025/0327737 A1
(43) Pub. Date: Oct. 23, 2025

(54) OPTO-ACOUSTIC MICROSCOPY USING AN INSTANTANEOUS SIGNAL DIFFERENCE BETWEEN SIGNALS FROM TWO DISCRETE DELAY TIMES ACQUIRED WITH A SINGLE PROBE BEAM

(71) Applicant: Onto Innovation Inc., Wilmington, MA (US)

(72) Inventors: Robin A. Mair, West Chicago, IL (US); Michael J. Kotelyanskii, Chatham, NJ (US); Manjusha Mehendale, Morristown, NJ (US); George Andrew Antonelli, Flanders, NJ (US)

(73) Assignee: Onto Innovation Inc., Wilmington, MA (US)

(21) Appl. No.: 18/986,597

(22) Filed: Dec. 18, 2024

Related U.S. Application Data
(60) Provisional application No. 63/636,334, filed on Apr. 19, 2024.

(51) Int. Cl. G01N 21/17; G01N 21/95

(52) U.S. Cl. CPC G01N 21/1702; G01N 21/9505; G01N 2021/1706

(57) ABSTRACT

A measuring device detects buried structures in a sample, such as voids or other underlying structures, based on an instantaneous signal difference determined from a single signal acquisition. The single signal acquisition is produced using a series of primary pump pulses and series of secondary pump pulses, which are intensity modulated and opposite in phase. The primary pump pulses and secondary pump pulses are combined to form a pump beam that is incident on the sample causing transient perturbations in material in the sample. Probe pulses are likewise incident on the sample and each probe pulse is modulated by the combined transient perturbations caused by a preceding primary pump pulse and a preceding secondary pump pulse. A series of reflected probe pulses are detected and demodulated to determine an instantaneous signal difference produced in response to the combined primary and secondary pump pulses, from which the buried structure is detected.

### CROSS REFERENCE TO RELATED APPLICATIONS

This application claims priority under 35 U.S.C. § 119 to U.S. Provisional Application No. 63/636,334, filed Apr. 19, 2024, entitled “Metrology Based on Time Resolved Non-Acoustic Signals,” which is incorporated by reference in its entirety.

### FIELD OF THE DISCLOSURE

The subject matter described herein is related generally to microscopy, and more particularly to the use of time resolved reflectivity and deflection measurements.

### BACKGROUND

Inspection and measurement of materials or products to help ensure the quality of those products is a useful step in manufacturing. The same is true for semiconductor wafers or similar products that include microscopic elements that are not easily measured. Metrology systems have been previously used to make measurements of such wafers. Improvements to those metrology systems, including power consumption, throughput, and performance are advantageous.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Opto-acoustic metrology, in general, uses a pump beam and a probe beam with a varying time delay between light pulses in each of the pump and probe beams. The light pulses in the pump beam produce an acoustic response within the sample under test that propagates to the surface of the sample, which is detected by the probe beam. The acoustic response, for example affects the reflectivity of the material in the sample or deflection of the probe beam. The varying time delay between light pulses is used to generate time resolved reflectance measurements of the sample. Opto-acoustic metrology is useful as it enables the non-destructive detection and measurement of underlying structures in the sample, which may be difficult to otherwise detect. Opto-acoustic metrology, however, is a relatively slow process because at each measurement point the time delay between light pulses in the pump and probe beams must be varied through the range of time delays in order to obtain the time resolved reflectance measurements. As discussed herein, however, an opto-acoustic metrology device uses multiple pump beams with a fixed delay between the pulses in each pump beam and an instantaneous signal difference based on the difference between the signals produced by the two pump beams. The two pump beams with two discrete delay times, for example, may be produced by splitting a pump beam into a primary pump beam and a secondary pump beam that have different path lengths and that are recombined before being incident on the sample. The use of multiple pump beams and the instantaneous signal difference may increase the measurement speed and throughput, while maintaining the desired accuracy of the measurement.

Buried structures, such as voids, inclusions or other underlying structures, are detected using a time resolved reflectance metrology device based on the instantaneous signal difference determined from a single time resolved transient signal acquisition. The time resolved transient signal is produced using a series of primary pump pulses and series of secondary pump pulses, which are intensity modulated and are opposite in phase and have a fixed time delay between them. Each pulse in the series of primary pump pulses and the series of secondary pump pulses produce transient perturbations in material in the sample. A corresponding series of probe pulses are likewise incident on the sample and reflected from the sample, where each reflected probe pulse is modulated by transient perturbations caused by both a preceding primary pump pulse and a preceding secondary pump pulse. Each probe pulse has a time delay with respect to the preceding primary pump pulse and a different time delay with respect to the preceding secondary pump pulse, and consequently, each reflected probe pulse is simultaneously modulated by transient perturbations from different depths in the sample. A series of reflected probe pulses is detected and demodulated based on the intensity modulation of the primary and secondary pump pulses to determine an instantaneous signal difference produced in response to the combined primary and secondary pump pulses. The instantaneous signal difference is used to determine a characteristic of the sample, such as the presence or absence of a buried structure.

In one implementation, a method for non-destructively characterizing a sample using an instantaneous signal difference that is a difference between signals produced by different delay times from multiple pump beams acquired with a single probe beam includes irradiating the sample with a pump beam that includes a series of primary pump pulses and a series of secondary pump pulses. The series of primary pump pulses and the series of secondary pump pulses are intensity modulated and are opposite in phase and the secondary pump pulses have a fixed delay with respect to the primary pump pulses. Each primary pump pulse and each secondary pump pulse cause transient perturbations in material in the sample. The method further includes irradiating the sample with a probe beam that includes a series of probe pulses. Each probe pulse has a first delay with respect to a preceding primary pump pulse and a second delay with respect to a preceding secondary pump pulse, the second delay being different than the first delay. The series of probe pulses is reflected from the sample as a series of reflected probe pulses, where each reflected probe pulse is modulated by the transient perturbations in the material in the sample caused by both the preceding primary pump pulse and the preceding secondary pump pulse. The method further includes detecting an instantaneous signal difference in the series of reflected probe pulses produced in response to the series of primary pump pulses and the series of secondary pump pulses, and determining a characteristic of the sample based on the instantaneous signal difference.

In one implementation, a metrology device for non-destructively characterizing a sample using an instantaneous signal difference that is a difference between signals produced by different delay times from multiple pump beams acquired with a single probe beam includes a pump arm that irradiates the sample with a pump beam that includes a series of primary pump pulses and a series of secondary pump pulses. The series of primary pump pulses and the series of secondary pump pulses are intensity modulated and are opposite in phase and the secondary pump pulses have a fixed delay with respect to the primary pump pulses. Each primary pump pulse and each secondary pump pulse cause transient perturbations in material in the sample. The metrology device further includes a probe arm that irradiates the sample with a probe beam that includes a series of probe pulses. Each probe pulse has a first delay with respect to a preceding primary pump pulse and a second delay with respect to a preceding secondary pump pulse, the second delay being different than the first delay. The series of probe pulses is reflected from the sample as a series of reflected probe pulses, where each reflected probe pulse is modulated by the transient perturbations in the material in the sample caused by both the preceding primary pump pulse and the preceding secondary pump pulse. The metrology device further includes a detector that detects the series of reflected probe pulses to determine an instantaneous signal difference in the series of reflected probe pulses produced in response to the series of primary pump pulses and the series of secondary pump pulses, and at least one processor coupled to the detector and is configured to determine a characteristic of the sample based on the instantaneous signal difference.

### BRIEF DESCRIPTION OF THE DRAWINGS

FIG. 1 illustrates a schematic representation of an example time resolved metrology device that is configured to perform time resolved reflectance measurements using instantaneous signal differencing, as discussed herein.

FIG. 2 illustrates a block diagram of another example time resolved metrology device that is configured to perform time resolved reflectance measurements using instantaneous signal differencing, as discussed herein.

FIG. 3 is a graph illustrating the intensity modulation of the primary pump beam and secondary pump beam.

FIG. 4 graphically illustrates the primary pump beam, the secondary pump beam, the probe beam, and the detected reflected probe beam.

FIGS. 5A-5D illustrate the detection of buried structures in a sample having one or more metallic layers using instantaneous signal differencing from time resolved reflectance measurements produced in response to acoustic transient signals.

FIGS. 6A and 6B illustrate the detection of buried structures in a sample having no metallic layers (or other strongly absorbing material capable of producing acoustic signals) using time resolved reflectance measurements produced in response to non-acoustic transient signals.

FIG. 7 is a flow chart illustrating a process of non-destructively characterizing a sample using transient signals using instantaneous signal differencing.

### DETAILED DESCRIPTION

Non-destructive measurement and inspection techniques may be used to ensure proper processing of semiconductor or other similar devices. For example, during processing, a series of fabrication steps may be performed in which layers, such as insulating layers, polysilicon layers, and metal layers, are deposited and patterned. In another example, during processing advanced packaging processes may be used to interconnect two or more devices during packaging. During processing, e.g., fabrication and packaging, desired or undesired buried structures may be produced in the sample, e.g., structures under one or more layers. A sample may be a wafer, a panel, or any type of substrate. The detection or measurement of such structures using non-destructive metrology techniques may be necessary or desirable to ensure proper processing for proper operation of resulting devices and to increase yield.

By way of example, during advanced packaging processes, two or more wafers or substrates may be bonded together using a number of physical and chemical process techniques. During the bonding process, structures such as solid structures, voids, or inclusions may be intentionally or inadvertently formed between bonded layers. It may be desirable to detect the presence or measure such structures during processing. For example, the structures may be useful to ensure proper alignment of the wafers. Similar to fabrication processing techniques, structures may be formed in a series of processing steps, such as the deposition and patterning of material layers such as insulating layers, polysilicon layers, and metal layers. For proper operation of such devices, the successful formation, patterning, and alignment of successive layers during fabrication and packaging is sometimes crucial. Moreover, inadvertently formed structures may affect the final performance of devices and, accordingly, may adversely affect the overall yield. If undesired characteristics, such as improper alignment or undesired structures, are detected, it may be possible to rework bonded wafers before additional processing is performed, such as polishing, etc.

There are various conventional optical techniques that may be used for non-destructive metrology or inspection of devices during the processing, e.g., during fabrication or packaging. Non-destructive techniques for metrology or inspection of devices during processing, e.g., during fabrication or packaging, often rely on the use of light. For example, conventional techniques may use specific wavelengths of light, e.g., ultraviolet (UV), visible, or infrared (IR), to image or otherwise detect one or more structures produced during processing.

Typically, to conventionally detect or image buried structures, e.g., structures that are under one or more layers, light having wavelengths suitable to penetrate the overlying layers is used. However, conventional optical techniques are sometimes unsuitable for the measurement or detection of buried structures when the structures are under optically opaque layers or the structures are optically transparent to the specific wavelengths of light being employed. In some instances, for example, overlying layers, or the layer in which the structure is formed, may be formed with a material that is opaque to light, e.g., when the material is metal. In such instances, it may not be possible to conventionally image the buried structures. As another example, voids or inclusions may be buried in between layers that are underneath a full layer of silicon (Si), e.g., 750 μm. Such structures may be difficult to detect or image as the structure, e.g., voids or inclusion, is optically transparent to the light. In some instances, infrared imaging may be possible to image such structures, unless the structures are covered by opaque layers, e.g., metal layers. Unfortunately, the resolution of infrared imaging technology is limited, making such techniques generally unsuitable even for voids that are not covered by metal layers.

One type of non-destructive metrology technique that may be used to detect voids is confocal scanning acoustic microscopy (C-SAM), which uses acoustic signals. Unfortunately, for proper conduction of the acoustic signal with C-SAM technology the sample is submerged in water, which is generally undesirable for many samples, such as semiconductor or other similar devices. Moreover, C-Sam technology is not able to image relatively small voids, e.g., sizes below 10 μm, and therefore has limited use.

Opto-acoustic metrology, such as Picosecond Acoustic Microscopy (PAM), in general, may be used to detect and measure buried structures, including voids, inclusions, or solid structures. For example, interfacial voids that are generated during hybrid bonding process, such as chip to chip, chip to wafer, and wafer to wafer, may be detected and imaged using opto-acoustic metrology. Opto-acoustic metrology, in general, uses pump beams and probe beams with a varying time delay between light pulses in the pump and probe beams to generate time resolved reflectance measurements. A metrology device that performs time resolved reflectance measurements, for example, may implement a variable time delay between the pump pulses and the probe pulses using a mechanically translating delay line that, e.g., alters the length of the beam path of the pump or probe beam, or using an asynchronous optical sampling (ASOPS) configuration, in which two synchronized light sources, e.g., lasers, with slightly different repetition rates produce the variable time delay without use of a mechanically translating delay line. The light pulses in the pump beam produce an acoustic response within the sample under test that propagates to the surface of the sample, which is detected after a delay by the probe beam. The acoustic response, for example affects the reflectivity of the material in the sample or deflection of the probe beam. The varying time delay between light pulses is used to generate time resolved reflectance measurements of the sample. Opto-acoustic metrology is useful as it enables the non-destructive detection and measurement of underlying structures in the sample, which may be difficult to otherwise detect. Opto-acoustic metrology, however, is a relatively slow process because at each measurement point the time delay between light pulses must be varied through the range of time delays in order to obtain the time resolved reflectance measurements before moving to the next measurement point and repeating the process.

As discussed herein, opto-acoustic metrology systems, such as PAM, use multiple pump beams with a fixed delay between the pulses in each pump beam and an instantaneous signal difference, e.g., a difference of signals from two discrete delay times, is acquired with a single probe beam. With the use of two or more fixed time delays from multiple pump beams instead of a varying time delay for a single pump beam and the instantaneous signal difference, measurement speed and throughput may be increased, while maintaining the desired accuracy of the measurement. In some implementations, the probe beam pulses and the pulses in the multiple pump beams may have a varying time delay. In some implementations, the probe beam pulses and the pulses in the multiple pump beams may have a fixed time delays so that there are multiple fixed time delays between pump pulses and probe pulses instead of a varying time delay. Signals received at two or more fixed time delays may have sufficient information and sensitivity to discriminate the presence or absence of a buried structure, such as a void, inclusion or solid structure, in a sample.

With the use of a fixed time delay between the pulses in the pump beams, an instantaneous signal difference, e.g., a difference of signals from two discrete delay times acquired with a single probe beam, may be obtained. The signal difference, for example, may be obtained by harvesting the conventionally rejected modulated pump laser pulses and re-purposing these pump laser pulses as a secondary pump pulse train, which is combined with the primary pump pulse train. For example, pump pulses may be intensity modulated using an optical modulator, such as an electro-optic modulator (EOM) or other suitable modulator, followed by a linear polarizing element. The pulses in primary pump train and the secondary pump train are delayed with respect to each other, e.g., using a difference in the light of the separate beam paths, to produce two different time delays with respect to the pulses in the probe pulse train. The pump-probe time delays for the primary pump pulse train and the secondary pump pulse train may be fixed during measurement, but may be altered, e.g., by changing the length of one or more beam paths, between measurements, e.g., to increase sensitivity.

The modulator and polarizing element pair imparts an intensity modulation onto the primary pump pulse train and secondary pump pulse train before they are combined and directed to the sample. The primary pump pulse train and the secondary pump pulse train are both intensity modulated, but are opposite in phase, i.e., 180 degrees out of phase with respect to each other. The probe pulse train, which is also directed to the sample at the measurement location, interacts with the photoexcited sample and picks up the pump modulation frequency through acoustic generation and detection as well as other transient processes driven by the pump excitation produced by the combined primary pump pulse train and the secondary pump pulse train. The resultant signal produced by the probe pulse train may be demodulated to determine the instantaneous signal difference produced in response to the different time delays of the primary pump pulse train and the secondary pump pulse train.

Use of an instantaneous signal differencing is advantageous relative to a sequential differencing process. A sequential differencing process, for example, obtains signals at different times for a first time delay and second time delay, and then calculates the difference in the signals. With the instantaneous signal differencing, the same signal is generated in response to both the first time delay and the second time delay in the primary probe pulse train and the secondary probe pulse. Accordingly, with use of simultaneous acquisition for the instantaneous signal differencing, the result may be obtained in roughly half the time as with a sequential process. Moreover, the simultaneous acquisition ensures exact positional agreement (lateral position on sample) for both the primary probe pulse train and the secondary probe pulse at each measurement location of a scan, which is particularly important to achieve maximum benefit of the differenced signal for suppression of unwanted signal artifacts.

The signal differencing process discussed herein, is compatible with both a homodyne configuration using a single light source that produces light that is split into the pump arm and probe arm and generate the pump-probe delay with a mechanical delay line, and a heterodyne configuration using two light sources, e.g., lasers, with slightly different repetition rates and that are electronically synchronized to generate the pump-probe delay without a mechanical delay line, such as asynchronous optical sampling (ASOPS). Both systems may be configured to set different fixed pump-probe delays for the primary pump pulses and secondary pump pulses, while in other implementations, the pump-probe delays for the primary pump pulses and secondary pump pulses may be varied during measurement to acquire a plurality of instantaneous signal differences at different pump-probe delays. As long as the configuration includes pump intensity modulation, either system may be augmented to capture and re-purpose the discarded pump pulses from the intensity modulation unit thereby enabling instantaneous signal differencing, as described herein.

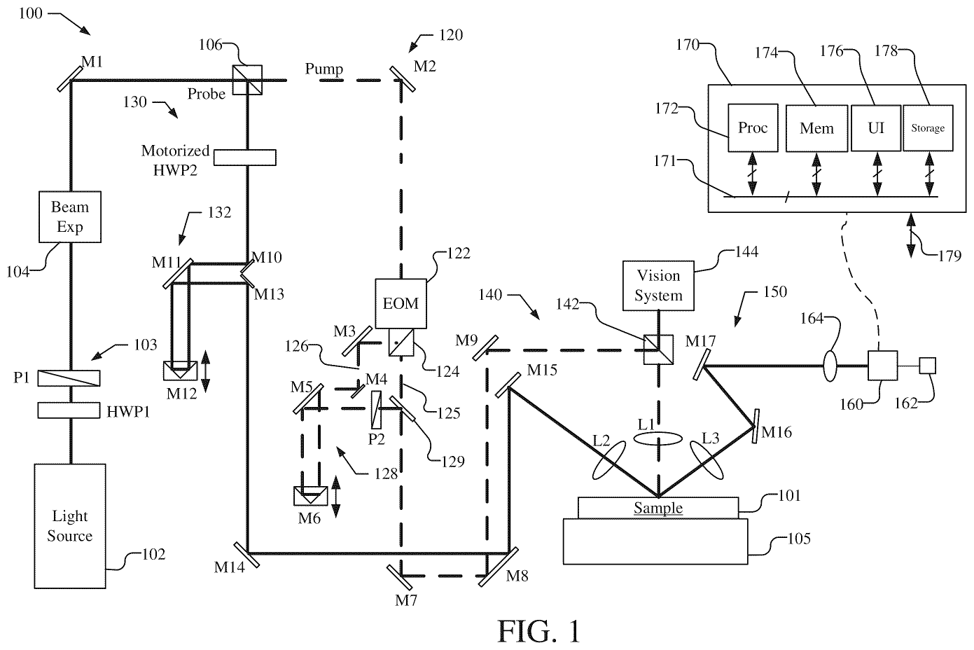

FIG. 1 illustrates a schematic representation of an example time resolved metrology device 100 that is configured to perform time resolved reflectance measurements using instantaneous signal differencing, as discussed herein. The signal differencing, for example, may be used for detecting and imaging buried structures, such as voids, inclusions, and solid structures.

As illustrated, the device 100 includes a light source 102 that produces a light beam that includes a series of light pulses. The light source 102, by way of example, may be laser, such as a 520 nm, 200 fs, 60 MHz laser, but other types of light sources or other characteristics may be used. For example, the device 100 may use light sources that operate in the infrared wavelength ranges, e.g., for imaging buried structures. The pulses in the light beam may be produced in various ways, such as by the pulsed laser, or in some implementations by a chopper that is external to the laser but may be considered as part of the light source 102. The light produced by light source 102 may be directed through an intensity control 103, which may include a half wave plate HWP1 and a polarizer P1, and may be directed through a beam expander 104. The beam may be directed by one or more optical elements, such as mirror M1, to beam splitter 106 that splits the light into a pump beam in the pump arm 120 and a probe beam in the probe arm 130.

In the pump arm 120, the pump beam is directed by mirror M2 to a pump beam optical modulator 122. The pump beam optical modulator 122, for example, may be an electro-optic modulator (EOM) or other suitable modulator, to intensity modulate the pump beam at a desired frequency, which may be in the range of several megahertz (MHz), such as about 5 or 5.5 MHz, but other frequencies may also be utilized.

The modulated pump beam is received by a pump beam splitter 124. The pump beam splitter 124 splits the modulated pump beam into a primary pump beam that travels along a primary pump beam path 125 and a secondary pump beam that travels along a secondary pump beam path 126. The primary pump beam and the secondary pump beam are both intensity modulated due to the pump beam optical modulator 122, but the intensity modulation of the secondary pump beam is 180 degrees out of phase with respect to the primary pump beam due to the pump beam splitter 124.

Conventionally, the secondary pump beam would be rejected from the system, e.g., by being received by a beam dump. As illustrated in FIG. 1, however, the secondary pump beam is used in the metrology device 100 and is recombined with the primary pump beam by a beam splitter 129. As illustrated, for example, the secondary pump beam travels along secondary pump beam path 126, where it is directed by various directional mirrors, e.g., M3 and M4, to an optical delay 128 that produces a delay between the pulses in the primary pump beam and the secondary pump beam. The optical delay 128, for example, is illustrated by mirrors M5 and M6. The mirror M6 may be a retroreflector. In some implementations, the mirror M6 may be coupled to an actuator or voice coil that may be controlled to vary the delay produced by the optical delay 128. As discussed herein, during measurement of a sample, the delay produced by the optical delay 128 may be fixed so that the delay between the pulses in the primary pump beam and the secondary pump beam is constant, but the delay may be altered between measurements, e.g., to improve sensitivity.

The primary pump beam will have a first delay between the pump beam splitter 124 and the beam splitter 129, while secondary pump beam will have a second, different, delay between the pump beam splitter 124 and the beam splitter 129. The optical delay 128 in the secondary pump beam path 126 may be controlled to set the delay difference with respect to the primary pump beam path 125, e.g., to improve signal sensitivity. Due to the extra reflective elements in the secondary pump beam path 126, such as mirrors M3, M4, M5, and M6, the total path length for secondary pump beam is greater than the total path length for the primary pump beam. Accordingly, pulses in the secondary pump beam will reach the focusing optics L1 and ultimately the sample 101, after the corresponding pulses in the primary pump beam.

Additionally, the series of reflections in the secondary pump beam path 126, e.g., by mirrors M3, M4, M5, and M6, may be configured so as to produce a 90 degree rotation in the orientation of the polarization of the secondary pump beam so that the primary pump beam and secondary pump beam have the same polarization orientation when combined by the beam splitter 129. In some implementations, additional mirrors may be located in the primary pump beam path 125 between the pump beam splitter 124 and the beam splitter 129 to assist in controlling the relative polarization orientations of the primary pump beam and secondary pump beam as well as controlling the first delay in the primary pump beam path 125. Additionally, a polarizing element P2, such as a polarizer or waveplate, may be located in the secondary pump beam path 126 before beam splitter 129 to ensure the primary pump beam and secondary pump beam have the same polarization orientation. Upon recombination by the beam splitter 129, the primary pump beam and secondary pump beam are co-linear, have the same polarization, are both are intensity modulated at the same frequency but are intensity modulated opposite in phase, and the pulses in the secondary pump beam are delayed with respect to the pulses in the primary pump beam.

The pump beam, i.e., combined primary pump beam and secondary pump beam, is directed by beam steering mirrors, e.g., mirrors M7, M8, and M9 to a focusing unit 140. At least one of the mirrors M7, M8, and M9 may be attached to a piezoelectric motor to adjust the direction of the pump beam. As illustrated in FIG. 1, the focusing unit 140 may include a beam splitter 142 that directs the pump beam through lens L1 to be normally incident on the sample 101. The lens L1 focuses the pump beam over an area of the sample 101 that includes the structure to be imaged. In some implementations, the pump beam may be directed to be obliquely incident on the sample 101, e.g., along the same beam path as the probe beam, which is focused by lens L2.

In the probe arm 130, after the beam splitter 106, the probe beam may pass through a half wave plate HWP2, which may be motorized to rotate. The probe beam may be directed to an optical delay 132 that includes mirrors M10, M11, M12, and M13. The mirror M12, for example, may be a retroreflector and may be a coupled to an actuator or voice coil that may be controlled to vary the delay of the probe beam with respect to the pump beam. The probe delay 132 may be used to control the delay between pulses in the pump beam and pulses in the probe beam, i.e., both the pulses in the primary pump beam and the pulses in the secondary pump beam. In some implementations, the delay 132 may be located in the pump arm 120, e.g., before the optical modulator 122, instead of being in the probe arm 130. In some implementations, separate delays may be located in both the pump arm 120 and the probe arm 130. The probe delay 132 may be held stationary during measurements for a fixed pump-probe delay, i.e., so that the pulses in the probe beam have a first fixed delay with respect to the pulses in the primary pump beam and a second, different fixed delay with respect to pulses in the secondary pump beam. In some implementations, the probe delay 132 may be move during measurements for a varying pump-probe delay, i.e., so that the pulses in the probe beam have a variable delay with respect to the pulses in the primary pump beam and a variable delay with respect to pulses in the secondary pump beam with a fixed delay between the pulses in the primary pump beam and secondary pump beam. The probe beam is directed by beam steering mirrors, e.g., mirrors M14, M8, M15, to the focusing unit 140. At least one of the mirrors M14, M8, and M15 may be attached to a piezoelectric motor to adjust the direction of the probe beam. As illustrated in FIG. 1, the focusing unit 140 may direct the probe beam through lens L2 to be obliquely incident on the sample 101. The lens L2 focuses the probe beam over an area of the sample 101 that includes the structure to be imaged and may be coincident with the area of incidence of the pump beam. In some implementations, similar to the pump beam, the probe beam may pass through a modulator, e.g., an EOM, followed by a polarizer to intensity modulate the probe beam, e.g., with a different frequency comb than the pump beam. If desired, additional optical components, such as waveplates may also be included for polarization control.

The lenses L1 and L2, for example, may be configured to irradiate the sample 101 with the pump beam and the probe beam. The pump beam and probe beam may be coincident at the same measurement location on the sample 101. In some implementations, the measurement location may be at least a size of dimensions of a structure under test on the sample 101 so that scanning is not required to detect the desired structure, such as an alignment or overlay pattern. In some implementations, for example, the lenses L1 and L2 may have a focal area greater than 10 μm. In some implementations, the measurement location may be laterally scanned over the surface of the sample 101 by producing relative motion between the sample 101 and the optical system, e.g., using a stage 105 that holds the sample 101, so that various locations on the sample 101 may be measured.

The reflected probe beam (and optionally reflected pump beam if obliquely incident) is received by a collection optics 150 that includes, e.g., lens L3 and mirrors M16 and M17. The reflected beam is directed to a detector 160 via lens 164. The detector 160 be a photodetector or a multi-pixel array of photodetectors. An image of the sample 101 may be generated, for example, using a multi-pixel array in the detector 160, if present, or by scanning the sample 101 (and/or optics) to a plurality of locations and performing measurements at each separate location.

The detector 160 may be coupled to a demodulator 162, such as a lock-in amplifier that is configured for phase locking during acquisition of signals. In some implementations, the detector 160 may be a lock-in camera that includes a multi-pixel array and independent phase locking for each pixel in the multi-pixel array. The phase locking is used to demodulate the received probe beam based on the frequency of the intensity modulation of the pump beam, or the combination of frequencies in both the pump beam and probe beam if the probe beam is also modulated. In implementations in which both the pump pulses in the pump beam and probe pulses in the probe beam are modulated with two different frequency combs (e.g., by modulators in both pump arm 120 and probe arm 130), the phase locking may be used to demodulate the combination, e.g., sum or difference, of the frequencies. Moreover, the phase locking may generate in-phase measurements and quadrature measurements from the images. The detector 160 may record a change in reflectance of the sample 101 as a function of the instantaneous signal difference that results from the fixed time delay between the primary pump pulses and the secondary pump pulses. With the reflectance measurements, the reflectivity or deflection of the sample 101 may be determined as the instantaneous signal difference. The instantaneous signal difference for example, may be a differential reflectivity or change in reflectivity measurement (ΔR/R), which is a due to the presence of strain and its associated change of the optical constants of the materials in the sample 101, or surface or interface deflection measurement, which is due to the physical deflection of the beam due to the presence of a strain at a surface or interface of the sample 101. It should be understood that for case of reference, the reflectivity or deflection from the sample collectively may sometimes be referred to herein generally as reflectance.

In addition, the time resolved metrology device 100 may be coupled with an imaging device 144 that may be configured to image the top structure of the sample 101 via beam splitter 142 and lens L1. The imaging device 144, for example, may be the navigation channel camera.

The sample 101 is held on a stage 105 that includes or is coupled to one or more actuators configured to move the sample 101 relative to the optical system of the time resolved metrology device 100 so that various locations on the sample 101 may be measured. In the depicted implementation, the device may include additional components and subsystems, such as beam management and conditioning components, such as beam expanders, collimators, polarizers, half-wave plates, etc., as well as a beam power detector, and a height detector. Those having skill in the art will appreciate variations of the devices depicted in FIG. 1 that would still be suitable to carry out the time resolved reflectance metrology techniques described herein.

The detector 160, as well as other components of the time resolved reflectance metrology device 100, may be coupled to a processing system 170, such as a workstation, a personal computer, central processing unit or other adequate computer system, or multiple systems. It should be understood that one processor, multiple separate processors or multiple linked processors may be used, all of which may interchangeably be referred to herein as processing system 170. The processing system 170 is preferably included in, or is connected to, or otherwise associated with time resolved reflectance metrology device 100. The processing system 170, for example, may control the positioning of the sample 101, e.g., by controlling movement of the stage 105 on which the sample 101 is held. The stage 105, for example, may be capable of horizontal motion in either Cartesian (i.e., X and Y) coordinates, or Polar (i.e., R and θ) coordinates or some combination of the two. The stage 105 may also be capable of vertical motion along the Z coordinate. The processing system 170 may further control the operation of a chuck on the stage 105 used to hold or release the sample 101.

The processing system 170 may collect and analyze the data obtained from the detector 160 and demodulator 162. In some implementations, the processing system 170 may function as the demodulator 162. The processing system 170 may analyze the time resolved metrology data to detect and image a buried structure, such as voids, inclusions, and solid structures, in the sample 101. For example, in some implementations, an underlying structure may be detected and imaged based on analysis of the instantaneous signal difference to differentiate between various attributes or traits of the transient signals from different locations. The attributes or traits of the transient signals from different locations may be used to determine whether the measurements are carried out at locations with voids or locations without voids. The transient signals, for example, may be acoustic transient signals or non-acoustic transient signals, i.e., signals in which contributions from any acoustic signal is less than the contributions produced by other physical phenomena such as one or more of thermal dissipation, electron-hole recombination, plasma diffusion, symmetry breaking at top and bottom oxide surfaces, etalon effects, etc. The underlying structures may be detected based on a comparison of the signal difference produced by the transient signals from a plurality of different locations. The processing system 170 may alternatively or additional process the time resolved reflectance metrology data for edge detection or triangulation, e.g., using a classification library or neural network generated by the time resolved reflectance metrology device 100 (or another device) on a reference sample.

The processing system 170, which includes at least one processor 172 with memory 174, as well as a user interface 176, which may include a display and input devices, such as key board and mouse, which may be interconnected via a bus 171. A non-transitory computer-usable storage medium 178 having computer-readable program code embodied may be used by the processing system 170 for causing the processing system 170 to control the time resolved metrology device 100 and to perform the functions including the analysis described herein. The data structures, software code, etc., for automatically implementing one or more acts described in this detailed description can be implemented by one of ordinary skill in the art in light of the present disclosure and stored, e.g., on a computer-usable storage medium 178, which may be any device or medium that can store code and/or data for use by a computer system such as the at least one processor 172. The computer-usable storage medium 178 may be, but is not limited to, flash drive, magnetic and optical storage devices such as disk drives, magnetic tape, compact discs, and DVDs (digital versatile discs or digital video discs). A communication port 179 may also be used to receive instructions that are used to program the processing system 170 to perform any one or more of the functions described herein and may represent any type of communication connection, such as to the internet or any other computer network. The communication port 179 may further export signals, e.g., measurement or inspection results and/or instructions, to another system, such as external process tools, in a feed forward or feedback process in order to adjust a process parameter associated with a process steps of the samples or provide rework instructions. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described. The results from the analysis of the data may be stored, e.g., in memory 174 associated with the sample and/or provided to a user, e.g., via UI 176, an alarm or other output device.

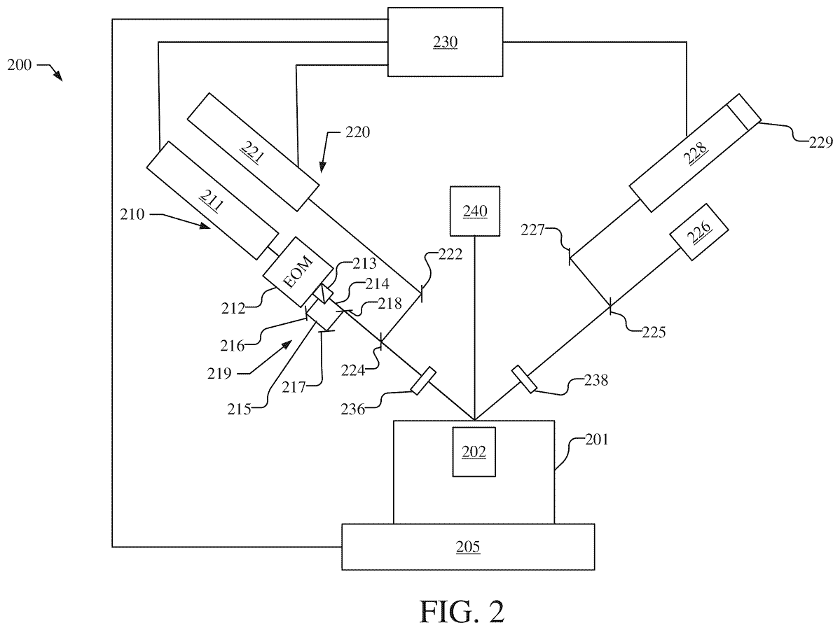

FIG. 2 illustrates a block diagram of another example time resolved metrology device 200 that is configured to perform time resolved reflectance measurements using instantaneous signal differencing, as discussed herein.

The device 200 includes a pump arm 210 that includes pump laser 211 (also referred to herein as an excitation laser), a probe arm 220 that includes a probe laser 221 (also referred to herein as a detection laser), and optics, such as turning mirror 222 and beam splitter 224. The device 200 further includes lenses 236 and 238, filters, polarizers and the like (not shown) that direct light from the pump and probe lasers 211, 221 to the sample 201 that includes a buried structure 202 to be detected or imaged. The pump and probe lasers 211 and 221 may be synchronized with different repetition rates to produce a varying pump-probe delay in an asynchronous optical sampling (ASOPS) configuration. In some implementations, the pump and probe lasers 211 and 221 may be synchronized with the same repetition rate to produce a fixed pump-probe delay during measurements.

Similar to metrology device 100 discussed in FIG. 1, the pump arm 210 includes an optical modulator 212, which may be an electro-optic modulator (EOM) or other suitable modulator, to intensity modulate the pump beam at a desired frequency, which may be in the range of several megahertz (MHz), such as about 5 or 5.5 MHz, but other frequencies may also be utilized. In some implementations, a second modulator may be present in the probe arm 220 to modulate the probe pulses with a different modulation frequency, e.g., different frequency combs may be used. The pump arm 210 further includes a beam splitter 213 that receives the modulated pump beam from modulator 212 and splits the modulated pump beam into a primary pump beam that travels along a primary pump beam path 214 and a secondary pump beam that travels along a secondary pump beam path 215. The primary pump beam and the secondary pump beam are both intensity modulated with the same frequency due to the modulator 212, but are opposite in phase due to the pump beam splitter 213.

The secondary pump beam is recombined with the primary pump beam by a beam splitter 218. For example, as illustrated, the secondary pump beam travels along secondary pump beam path 215 which includes an optical delay 219, illustrated by mirrors 216 and 217, that produces a delay between the pulses in the primary pump beam and the secondary pump beam. If desired, the optical delay 219 may include a retroreflector, which may be coupled to an actuator or voice coil to controllably vary the delay produced by the optical delay 219. As discussed herein, during measurement of a sample, the delay produced by the optical delay 219 may be fixed so that the delay between the pulses in the primary pump beam and the secondary pump beam is constant but the delay may be altered between measurements, e.g., to improve sensitivity.

Thus, the optical delay 219 in the secondary pump beam path 215 may be controlled to set the delay difference with respect to the primary pump beam path 214. Due to the extra reflective elements in the secondary pump beam path 215, illustrated by mirrors 216 and 217, the total path length for secondary pump beam is greater than the total path length for the primary pump beam. Accordingly, pulses in the secondary pump beam will reach the focusing optics 236 and ultimately the sample 201, after the corresponding pulses in the primary pump beam.

Additionally, the series of reflections in the secondary pump beam path 215, e.g., illustrated by mirrors 216 and 217, may be configured so as to produce a 90 degree rotation in the orientation of the polarization of the secondary pump beam so that the primary pump beam and secondary pump beam have the same polarization orientation when combined by the beam splitter 218. In some implementations, mirrors may be located in the primary pump beam path 214 to assist in controlling the relative polarization orientations of the primary pump beam and secondary pump beam as well as controlling the delay in the primary pump beam path 214. Additionally, a polarizing element, such as a polarizer or waveplate, may be located in the secondary pump beam path 215 before beam splitter 218 to ensure the primary pump beam and secondary pump beam have the same polarization orientation. Upon recombination by the beam splitter 218, the primary pump beam and secondary pump beam are co-linear, have the same polarization, are both are intensity modulated at the same frequency but are opposite in phase, and the pulses in the secondary pump beam are delayed with respect to the pulses in the primary pump beam.

The device 200 may include optics such as beam splitter 225 and turning mirror 227 and may include a beam dump 226 for capturing radiation from the pump laser returned from the sample 201. The device 200 includes a detector 228 that detects a change in reflectance, e.g., due to changes in reflectivity or surface deformation of the sample 201, from the reflected probe beam.

In some implementations, the detector 228 may be coupled to a demodulator 229, such as a lock-in amplifier that is configured for phase locking during acquisition of signals. In some implementations, the detector 228 may be a lock-in camera that includes a multi-pixel array and independent phase locking for each pixel in the multi-pixel array.

The phase locking is used to demodulate the received probe beam based on the frequency of the intensity modulation of the pump beam, or the combination of frequencies in both the pump beam and probe beam if the probe beam is also modulated. In implementations in which both the pump pulses in the pump beam and probe pulses in the probe beam are modulated with two different frequency combs (e.g., by modulators in both pump arm 210 and probe arm 220), the phase locking may be used to demodulate the combination, e.g., sum or difference, of the frequencies. Moreover, the phase locking may generate in-phase measurements and quadrature measurements from the images. The detector 228 records the reflectance of the sample 201 as a function of the instantaneous signal difference that results from the fixed time delay between the primary pump pulses and the secondary pump pulses.

The device 200 further includes a mechatronic support stage 205 for a sample 201 with buried structure 202, the stage 205 being adapted to move the sample 201 relative to the pump and probe lasers 211, 221 to obtain measurements at multiple locations sequentially, e.g., in a raster scan.

The detector 228, as well as other components of the time resolved reflectance metrology device 200, may be coupled to a processing system 230, which may be the similar to the processing system 170 discussed in reference to FIG. 1. It should be appreciated that the processing system 230 may be a self-contained or distributed computing device capable of performing computations, receiving, and sending instructions or commands and of receiving, storing, and sending information related to the metrology functions of the device.

In the depicted implementation, the pump and probe lasers 211, 221 in the implementation of the time resolved metrology device 200 shown in FIG. 2 can share at least a portion of an optical path to and from the sample 201. For example, the lasers can have a number of different relative arrangements including a configuration wherein the paths are the same, partially overlapping, adjacent, or coaxial. In some implementations, the pump and probe beams may be derived from the same pulsed laser. In some implementations, as illustrated in FIG. 2, separate lasers may be used for the pump and probe beams, e.g., separate synchronized lasers with slightly different repetition rates may be used in the ASOPS configuration. In other implementations, the pump and probe lasers 211, 221 and the beam dump 226 and detector 228 do not share optical paths. For example, the pump beam from the pump laser 211 may be normally incident on the sample 201, while the probe beam from the probe laser 221 may be obliquely incident on the sample 201. The pump and probe lasers 211, 221 may be controlled directly so as to obtain the temporal spacing between the pulses of light directed to the structure 202.

It should be appreciated that many optical configurations are possible. In some configurations the pump can be a pulsed laser with a pulse width in the range of several hundred femtoseconds to several hundred nanoseconds and the probe beam is coupled to a beam deflection system. For example, in some implementations, the pump arm 210 and/or the probe arm 220 may include a mechanical delay stage (not shown) for increasing or decreasing the length of the optical path difference between the pump beam and the probe beam. The delay stage, where provided, would be controlled by processing system 230 to obtain and control the time delay between the pump and probe light pulses that are incident on the object. Many other alternative configurations are also possible. In other implementations, such as with an ASOPS configuration, the device may not include a delay stage. It should be appreciated that the schematic illustration of FIG. 2 is not intended to be limiting, but rather depict one of a number of example configurations.

In operation, the time resolved metrology device 200 directs a series of primary pump pulses and a series of secondary pump pulses from the pump laser 211 to the structure 202. These pulses of light are incident on the sample 201, e.g., at an angle which can be any angle between zero to 90 degrees including, for example, 45 degrees and 90 degrees). If the sample 201 includes an at least partially absorbing transducer layer, e.g., a metallic layer, above the structure 202, the primary pump pulses and the secondary pump pulses from the pump laser 211 are at least partially absorbed causing a transient expansion, i.e., acoustic signal, in the material of the transducer layer. The expansion is short enough that it induces what is essentially an ultrasonic wave that propagates vertically through the structure 202 and is reflected at each underlying interface and is returned to the top surface. Light from the pump laser 211 that is reflected from the structure 202 is passed into a beam dump 226 which extinguishes or absorbs the pump radiation.

If the sample 201 does not include a strongly absorbing material such as a metallic layer, and only includes materials that are optically transparent to the wavelengths used by the pump laser 211, there may be no (or only a minor) transient expansion, i.e., acoustic signal, that is produced. Nevertheless, a non-acoustic transient signal in the sample 201 is produced in response to the primary pump pulses and the secondary pump pulses from one or more different physical phenomena, such as thermal dissipation, electron-hole recombination (e.g., possible generated in Si), plasma diffusion, symmetry breaking at top and bottom oxide surfaces, etalon effects within a void, etc. Without a strongly absorbing material to produce an acoustic signal, the non-acoustic contributions to the return signal become more prominent and sensitive to the presence of structures, such as voids in oxide layers.

In addition to directing the operation of the pump laser 211, the processing system 230 directs the operation of the probe laser 221. Probe laser 221 directs radiation in a series of probe pulses that is incident on the sample 201, which reflect from the sample 201 and is affected by the resulting transient signals, e.g., reflected acoustic signals if the sample 201 includes a strongly absorbing material to produce acoustic signals, or the non-acoustic transient signals if strongly absorbing materials are not present in the sample 201.

The device 200 includes optics, such as lens 236, that may be configured to adjust the spot sizes of the pump beam and probe beam. The spot sizes of the respective beams may be similar or dissimilar. For example, the optics, such as lens 236, may be configured to adjust a focal area of the pump pulses and the probe pulses on the sample 201 to a size that includes a plurality of locations to be measured, e.g., using a lock-in camera that includes a multi-pixel array as the detector 228, or to a size that corresponds to a single location, if the detector 228 is a single pixel detector and scanning is used to measure the plurality of locations.

The light reflected from the surface of the sample 201 is directed to the detector 228, e.g., by beam splitter 225. The reflectance of the reflected probe beam is modulated due to changes in reflectivity or surface deformation due to the reflected acoustic waves or the non-acoustic transient signals in response to the primary pump pulses and the secondary pump pulses. The detector 228 may be configured to receive and demodulate the reflected probe pulses, e.g., using the demodulator 229.

In implementations in which the detector 228 includes a multi-pixel array, the optics, such as lens 238, may adjust the magnification of the probe beam on the multi-pixel array for efficiency. The detector 228 may include the demodulator 229 that is configured for phase locking to acquire the transient signals. If the detector 228 includes the multi-pixel array, the demodulator 229 may be configured for independent phase locking for each pixel in the multi-pixel array for parallel acquisition of transient signals. In some implementations, the demodulator 229 may be independent of the detector 228, e.g., in a separate processor or Field Programmable Gate Array (FPGA) or in the processing system 230. The phase locking may be used to demodulate the frequency of the pump pulses in the received probe beam. If both the pump pulses and probe pulses are modulated, a combination, e.g., a sum or difference, of the frequencies in the received probe beam may be demodulated. The detector 228 may record a change in reflectance of the sample 201, e.g., for each illuminated pixel, as an instantaneous signal difference in response to the different time delays of the primary pump pulse train and the secondary pump pulse train.

In addition, the time resolved reflectance metrology device 200 may be coupled with an imaging device 240 that is configured to image the top surface of the sample 201, e.g., for alignment or overlay purposes. The imaging device 240, for example, may be the navigation channel camera. The imaging device 240 may perform optical imaging of the sample 201.

The metrology devices 100 and 200 shown in FIGS. 1 and 2 are configured to produce a fixed time delay between pulses in the primary pump beam and pulses in the secondary pump beam, which may be used to obtain an instantaneous signal difference (difference of signals from two discrete delay times) with a single acquisition. Conventionally, a single pump beam and sequential signal acquisition would be used to determine a signal difference, e.g., two separate signals would be acquired at different times, and the difference between the signals would be calculated. For example, in a sequential acquisition, signals would be acquired with the pump-probe delay set to a first time delay A, e.g., during a scan over a region of interest on the sample, followed by adjusting the pump-probe delay to a second time delay B and acquiring a second set of signals, e.g., during a second scan over the region of interest. An image of the region of interest may be determined based on the difference in signals (Diff=A−B=A+−1*B) for each measurement location in the region of interest, where A represents the signal obtained at pump-probe delay A, B represents the signal obtained at pump-probe delay B, and Diff represents the difference.

With the metrology devices 100 and 200 shown in FIGS. 1 and 2, a secondary pump beam with a fixed delay with respect to the primary pump beam is used. Thus, the pulses in the primary pump beam and the pulses in the secondary pump beam have different time delays with respect to the same pulses in the probe beam. In this instance, A may represent the signal obtained in response to the pump-probe delay A of the primary pump beam, while B may represent the signal obtained in response to the pump-probe delay B of the secondary pump beam. The secondary pump beam is intensity modulated with the same frequency as the primary pump beam, but is 180 degrees out of phase. The signal produced by the probe beam is simultaneously in response to the combined primary pump beam and the second pump beam. Thus, the signal obtained in response to the pump-probe delay B of the secondary pump beam is inverted with respect to the signal obtained in response to the pump-probe delay A and may be represented as −1*B. By combining the primary pump beam and secondary pump beam that are modulated with the same frequency but are opposite in phase, the resulting signal after the detected probe beam is demodulated will be A−B, i.e., providing an instantaneous signal difference.

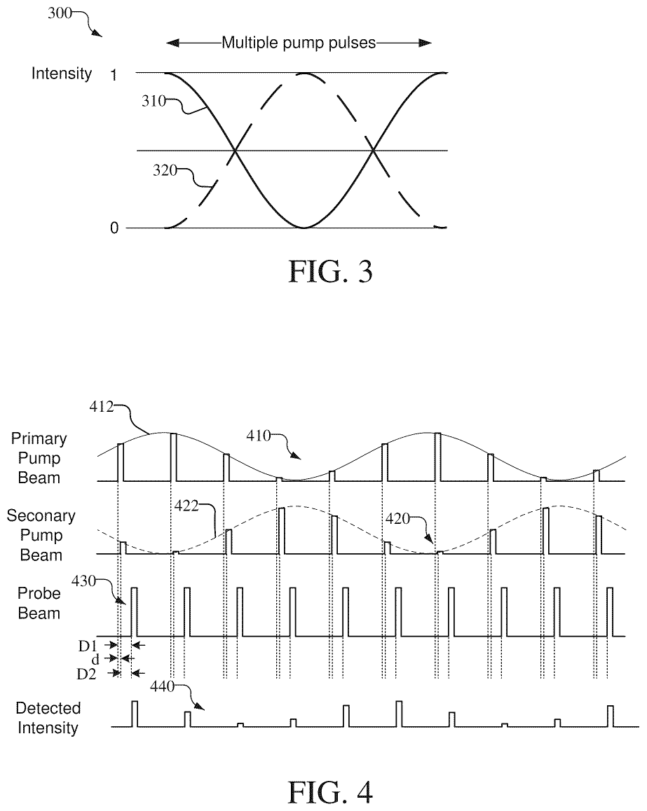

FIG. 3 is a graph 300 illustrating the intensity modulation of the primary pump beam and secondary pump beam in response to the optical modulator 122 and pump beam splitter 124 combination illustrated in FIG. 1 and the optical modulator 212 and pump beam splitter 213 combination illustrated in FIG. 2. In FIG. 3, the X axis represents time and the Y axis represents intensity in arbitrary units (AU) between 0 and 1.

In FIG. 3, solid curve 310 illustrates the intensity modulation of the primary pump beam, e.g., along primary pump beam path 125 after being modulated by the optical modulator 122 and split by the pump beam splitter 124 in FIG. 1, or similarly along the primary pump beam path 214 after being modulated by the optical modulator 212 and split by the pump beam splitter 213 in FIG. 2. The dashed curve 320, on the other hand, illustrates the intensity modulation of the secondary pump beam, e.g., along secondary pump beam path 126 after being modulated by the optical modulator 122 and split by the pump beam splitter 124 in FIG. 1, or similarly along the secondary pump beam path 215 after being modulated by the optical modulator 212 and split by the pump beam splitter 213 in FIG. 2. As illustrated by curves 310 and 320, the intensity modulation of the primary pump beam and the secondary pump beam are 180 degrees out of phase.

It should be understood that despite illustrating continuous curves 310 and 320 in FIG. 3, the primary pump beam and the secondary pump beam are not continuous beams, but are produced as a plurality of light pulses, sometimes referred to as a pulse train, with the intensity modulated as illustrated by curves 310 and 320. For example, within a single period of the intensity modulation, there may be tens, hundreds, or thousands of light pulses.

The pulses in the probe beam will have a first delay with respect to corresponding pulses in the primary pump beam and a different second delay with respect to corresponding pulses in the secondary pump beam due to the fixed delay between the pulses in the primary pump beam and the secondary pump beam. If the time delay between the probe beam and pump beam is held constant during measurements, the first delay and the second delay will be fixed. If the time delay between the probe beam and pump beam is varied during measurements, the probe beam will have the first delay and the second delay will vary, but will remain offset by the fixed delay between the pulses in the primary pump beam and the secondary pump beam.

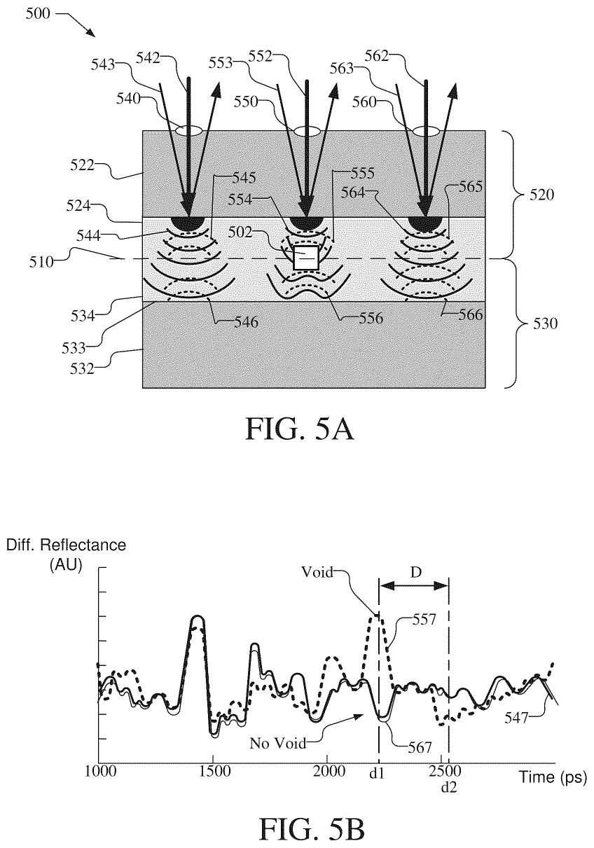

FIG. 4, by way of example, graphically illustrates the primary pump beam 410, the secondary pump beam 420, the probe beam 430, and the detected reflected probe beam 440. FIG. 4 illustrates a fixed pump-probe time delay. As illustrated, the primary pump beam 410, the secondary pump beam 420, and the probe beam 430 are produced by a number of light pulses. The intensity of the pulses in the primary pump beam 410 is modulated, as illustrated by solid curve 412, and the intensity of the pulses in the secondary pump beam 420 is modulated, as illustrated by dashed curve 422. The pulses in the probe beam 430 may not be modulated, but in some implementations, the probe beam 430 may also be modulated at a different frequency than the primary pump beam 410 and the secondary pump beam 420.

Due to the fixed pump-probe time delay illustrated in FIG. 4, each pulse in the primary pump beam 410 has a fixed delay D1 with respect to a corresponding pulse in the probe beam 430. Additionally, each pulse in the secondary pump beam 420 has a relatively small, fixed delay d with respect to a corresponding pulse in the primary pump beam 410 due to the longer length of the secondary pump beam path, as illustrated in FIGS. 1 and 2. Further, each pulse in the secondary pump beam 420 has a fixed delay D2 (D2=D1−d) with respect to a corresponding pulse in the probe beam 430. The intensity modulation of the pulses in the secondary pump beam 420 is 180 degrees out of phase with respect to the primary pump beam 410, but is shifted by the fixed delay d, which may be small relative to the intensity modulation period.

FIG. 4 further illustrates the idealized contributions from the primary pump beam and the secondary pump beam to the detected intensity of the reflected probe beam 440. Each pulse in the reflected probe beam 440 is produced in response to the primary pump beam 410 and the secondary pump beam 420. By demodulating the reflected probe beam 440 based on the frequency of the intensity modulation of the pump beam, the instantaneous signal difference for the contributions from the primary pump beam 410 and the secondary pump beam 420 is recovered.

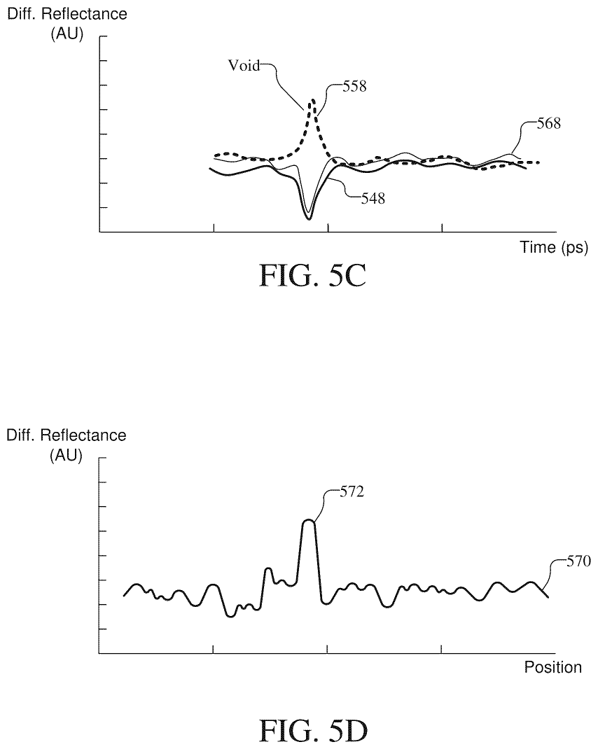

FIGS. 5A and 5B illustrate the detection of buried structures in a sample having one or more metallic layers using instantaneous signal differencing from time resolved reflectance measurements produced in response to acoustic transient signals. FIG. 5A illustrates a sample 500 that is formed by two bonded wafers 520 and 530 with a buried structure 502, disposed between wafers 520 and 530. The buried structure 502, for example, may be a void or other type of inclusion, and is sometimes referred to herein as void 502, but it should be understood that the buried structure 502 may be a solid structure. Wafer 520, for example, may include a silicon substrate 522 that may have a thickness of 750 μm thick, which serves as a top layer of the sample 500, and a metallic layer 524, which may be, e.g., copper (CU), tungsten (W), or titanium (Ti), and may have a thickness of 50 nm. Wafer 530 may similarly include a metallic layer 534, which may be, e.g., CU, W, or Ti, and may have a thickness of 50 nm, on a silicon substrate 532 that may have a thickness of 750 μm thick, that serves as a bottom layer of the sample 500. Layers 532 and 534 form interface 533. The metallic layers 524 and 534 are bonded together at an interface 510 as illustrated by line 510, with a void 502 disposed therebetween.

FIG. 5A further illustrates the measurement of acoustic transient signals at three different locations 540, 550, and 560 on the sample 500, where location 550 includes the buried void 502. Acoustic transient signals are generated due to the presence of an optically opaque material, e.g., metallic layer 534. The measurement of the acoustic transient signals may occur sequentially, e.g., during a lateral scan of the sample, or may occur in parallel, e.g., using the detector with a multi-pixel array.

At locations 540, 550, and 560, illumination from the pulses in the pump beams 542, 552, and 562 are illustrated as the normally incident solid arrows. The pump beam 542, 552, and 562 may be a combination of the primary pump beam and secondary pump beam, as discussed above. The pump beams 542, 552, and 562, for example, may use infrared wavelengths, that penetrate the silicon substrate 522 without significant absorption, but when incident on the metallic layer 524 produce transient expansions of the metallic layer 524 at the interface with the silicon substrate 522, generating acoustic perturbations 544, 554, and 564, respectively, as illustrated by solid curved lines. The acoustic perturbations 544, 554, and 564 propagate through the metallic layer 524 over time.

At locations 540 and 560, the acoustic perturbations 544 and 564 may be reflected at the interface 510 between the metallic layers 524 and 534 and is returned to the surface of the metallic layer 524 after a delay d1 as reflected acoustic perturbations 545, as illustrated by dotted curved lines. The remaining portions of the acoustic perturbations 544 564 continue to propagate through metallic layer 534 until it is at least partially reflected at the interface 533 between the metallic layer 534 and the silicon substrate 532 and is returned to the surface of the metallic layer 524 after a delay d2 as reflected acoustic perturbations 546 and 566, as illustrated by dotted curved lines.

At location 550, which includes the void 502, a portion of the acoustic perturbation 554 is reflected at the interface of the metallic layer 524 and the void 502 and is returned to the surface of the metallic layer 524 after a delay d1 as reflected acoustic perturbations 555, as illustrated by dotted curved lines. The remaining portion of the acoustic perturbation 554 may continue propagating through metallic layer 534 until it is at least partially reflected at the interface 533 between the metallic layer 534 and the silicon substrate 532 and may be returned to the surface of the metallic layer 524 after delay d2 as reflected acoustic perturbations 556, as illustrated by dotted curved lines.

The reflectance at locations 540, 550, and 560 is measured by probe beams 543, 553, and 563, which are illustrated as being incident on and reflected by the sample 500 at a non-normal angle of incidence. It should be understood, however, that the probe beams 543, 553, and 563 may be co-linear with pump beam 542, 552, and 562, or if desired, the pump beam 542, 552, and 562 may be incident on the sample 500 at a non-normal angle of incidence and the probe beams 543, 553, and 563 may be incident on and reflected by the sample 500 at a normal angle of incidence. The reflectance of the sample, e.g., at the interface of the metallic layer 524 and the silicon substrate 522 as measured by probe beams 543, 553, and 563 at locations 540, 550, and 560 is altered due to changes in reflectivity or surface deformation caused by the reflected transient perturbations, e.g., by the combination of reflected acoustic perturbations 545/546, 555/556, and 565/566, respectively.

As discussed above, the pump beams 542, 552, 562 are a combination of the primary pump beam and the secondary pump beam. The pulses in the pump beams 542, 552, 562 have fixed time delays between the primary pump beam and the secondary pump beam. The pulses in the probe beams 543, 553, 563 may have a fixed delay with respect to the pulses in the pump beams 542, 552, and 562, in which case there is a first fixed time delay with respect to a corresponding pulse in the primary pump beam and a second fixed time delay with respect to a corresponding pulse in the secondary pump beam. The reflected acoustic perturbations 545/546 at location 540, the reflected acoustic perturbations 555/556 at location 550, and the reflected acoustic perturbations 565/566 at location 560 will be returned to the surface of the metallic layer 524, i.e., the interface between metallic layer 524 and the silicon substrate 522, when a pulse from the probe beams 543, 553, and 563 are incident on the surface of the metallic layer 524. Accordingly, at location 540, the pulses in the probe beam 543 will be modulated due to changes in reflectance caused by the reflected acoustic perturbations 545 from interface 510 combined with reflected acoustic perturbations 546 from interface 533. Similarly, at location 560, the pulses in the probe beams 563 will be modulated due to changes in reflectance caused by reflected acoustic perturbations 565 from interface 510 combined with reflected acoustic perturbations 566 from interface 533. At location 550, however, the probe beam 553 will be modulated due to changes in reflectance caused by the reflected acoustic perturbation 555 from void 502 combined with the reflected acoustic perturbation 556 from interface 533.

In some implementations, the measurements at each location 540, 550, and 560 may be performed using a variable pump-probe delay, so that pulse in the probe beams 543, 553, 563 have variable delay with respect to the pulses in the pump beams 542, 552, and 562, and the first time delay with respect to a corresponding pulse in the primary pump beam and a second time delay with respect to a corresponding pulse in the secondary pump beam varies, but is offset by the fixed delay between the primary pump beam and secondary pump beam.

By demodulating the probe beams 543, 553, and 563, the instantaneous signal difference produced in response to the fixed time delay between the primary pump pulses and secondary pump pulses may be determined.

FIG. 5B illustrates an example graph of the acoustic transient signals 547, 557, and 567 received at locations 540, 550, and 560, respectively, in FIG. 5A. In the graph of FIG. 5B, the X axis represents the delay time between the pump pulses and the probe pulses in picoseconds (ps), and the Y axis represents the differential reflectance in arbitrary units (AU), i.e., the perturbation of the overall reflectance due to influence (at sample) of the pump as registered by the lock-in amplifier at the pump modulation frequency. The transient signals 547, 557, 567 are in response to acoustic signals generated in the sample at locations 540, 550 and 560 in response to a single pump beam, e.g., a pump beam that does not include the secondary pump beam, and that has a pump-probe delay time that varies from 1000 ps to approximately 3000 ps. It should be understood that the raw transient signals from a sample that includes a metallic layer or other strongly absorbing material may be a combination of an acoustic signal and a background signal, e.g., produced by thermal dissipation. The raw transient signals are typically processed to remove any background signal, such as thermal dissipation, which is generally a DC component, resulting in acoustic transient signals 547, 557, and 567.

As illustrated in FIG. 5B, the presence of a void or lack of a void is easily identified from the acoustic transient signals 547, 557, and 567. As can be seen, the acoustic transient signals 547, 557, and 567 are generally similar, except where the presence of a structure, such as void 502, is present. The presence of the void or lack of void is determined based on differences in the signal profile at a specific time delay that corresponds to when an acoustic echo is returned. For example, as illustrated in FIG. 5B, at approximately 2210 ps, the acoustic transient signals 547 and 567 experience a negative peak, while the acoustic transient signal 557 experiences a positive peak. Based on the difference between acoustic transient signals 547, 557, and 567 at the specific time delay corresponding to the depth at which the underlying structure is expected, e.g., 2210 ps, the presence of the void 502 at location 550 can be detected.

By a judicious selection of the fixed time delay between the pulses in the primary pump beam and the pulses in the secondary pump beam the sensitivity of the resulting instantaneous signal difference may be optimized. For example, the fixed time delay D between the pulses in the primary pump beam and the pulses in the secondary pump beam is illustrated as the distance between the first delay between the primary pump pulses and the probe pulses, e.g., delay d1 shown in FIG. 5B, and the second delay between the secondary pump pulses and the probe pulses, e.g., delay d2 shown in FIG. 5B.The instantaneous signal difference produced acoustic transient signal 557 will significantly differ from the instantaneous signal difference produced by acoustic transient signal 547 and 567 due to the presence of the void 502, and based on the instantaneous signal difference, the presence of the void 502 may be determined.

If the pump-probe delay varies during the measurements, multiple instantaneous signal differences resulting from the fixed time delay D at different pump-probe delays will be produced, e.g., the fixed time delay D is scanned across the X axis in FIG. 5B. FIG. 5C, by way of example, is a graph illustrating an instantaneous signal difference with a varying pump-probe delay with the X axis representing the varying pump-probe delay time in picoseconds (ps), and the Y axis represents the differential reflectance of the instantaneous signal difference in arbitrary units (AU). The instantaneous signal differences 548, 558, and 568, produced at locations 540, 550 and 560, respectively, in response to the fixed time delay between the primary pump beam and the secondary pump beam. As can be seen, the resulting instantaneous signal differences 558 produced at location 550 differs with respect to the resulting instantaneous signal differences 548 and 568 produced at locations 540 and 560, enabling detection and characterization of the sample.

If the pump-probe delay is fixed during the measurements, a single instantaneous signal differences resulting from the fixed time delay D at the fixed pump-probe delay will be produced, e.g., at the one position of the fixed time delay D on the X axis illustrated in FIG. 5B. FIG. 5D, by way of example, is a graph illustrating an instantaneous signal difference with a fixed pump-probe delay with the X axis representing position on the sample, and the Y axis represents the differential reflectance of the instantaneous signal difference in arbitrary units (AU). The instantaneous signal difference 570, for example, is produced by scanning the measurement spot over locations 540, 550 and 560 while maintaining a fixed pump-probe time delay and a fixed time delay between the primary pump beam and the secondary pump beam. As can be seen, the void 502, for example, produces a clear peak 572 in the resulting instantaneous signal differences 570 enabling detection and characterization of the sample.

In some implementations, the fixed time delay D between the pulses in the primary pump beam and the pulses in the secondary pump beam may be altered to adjust one or both of the first delay d1 and second delay d2, e.g., by altering one or both of the probe beam paths, to increase sensitivity to the instantaneous signal difference. Thus, the buried structures, e.g., layer interfaces and void 502 may be detected using instantaneous signal differencing using fixed time delays between the primary pump beam and secondary pump beam. By way of example, the instantaneous signal differencing based on the reflected acoustic perturbations from interfaces 510 and 533 corresponds to the thickness of the metal layer 534 at location 540, thus, a variation in the instantaneous signal difference may be used to indicate a variation in the thickness of the metal layer 534. Moreover, an image of the sample 500, including deviation from a nominal thickness of the metal layer 534 or the presence of absence of buried structures, such as void may be generated based on the instantaneous signal differencing of acoustic transient signals from the multiple locations, e.g., by laterally scanning the measurement location over the sample.

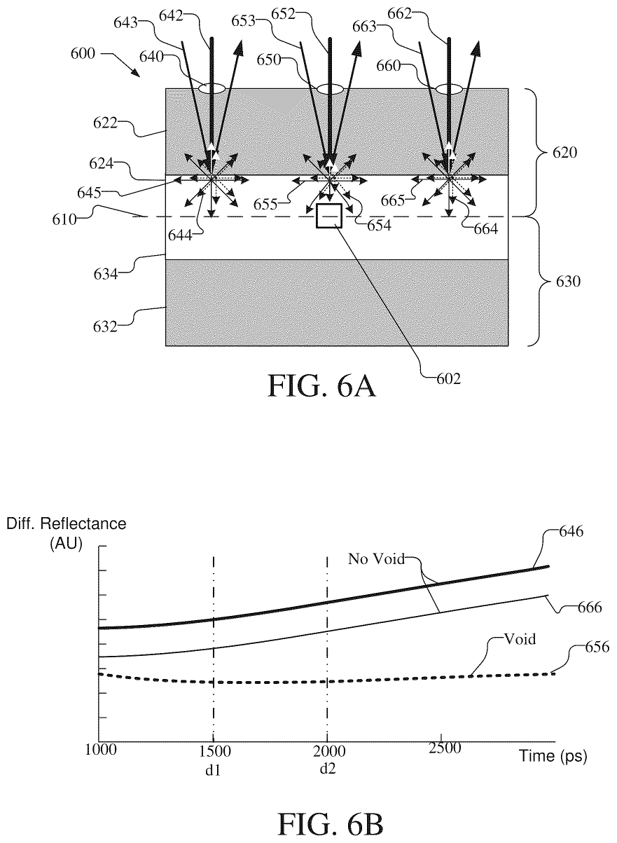

FIGS. 6A and 6B illustrate the detection of buried structures in a sample having no metallic layers (or other strongly absorbing material capable of producing acoustic signals) using time resolved reflectance measurements produced in response to non-acoustic transient signals. The reflectance measurements produced in response to the non-acoustic transient signals, for example, may be due to changes in reflectivity, although it may be possible that the non-acoustic transient signals may also or alternatively cause some changes in surface deformation, which might be detected in the reflectance measurements. FIG. 6A illustrates a sample 600 that is similar to sample 600 shown in FIG. 6A, except that sample 600 includes a silicon oxide (SiO₂) instead of a metallic layer. As illustrated, sample 600 is formed by two bonded wafers 620 and 630 with a buried structure in the form of a void 602 disposed between. Wafer 620, for example, includes a silicon substrate 622 that may have a thickness of 750 μm thick, which serves as a top layer of the sample 600, and a SiO₂ layer 624, which may have a thickness of 50 nm. Wafer 630 similarly includes a SiO₂ layer 634, which may have a thickness of 50 nm, on a silicon substrate 632 that may have a thickness of 750 μm thick, that serves as a bottom layer of the sample 600. The SiO₂ layers 624 and 634 are bonded together as illustrated by line 610, with a void 602 disposed therebetween.

FIG. 6A further illustrates the measurement of non-acoustic transient signals at three different locations 640, 650, and 660 on the sample 600, where location 650 includes the buried void 602. The sample 600 includes only optically transparent layers, i.e., there is no strongly absorbing materials that generates acoustic signals in response to the pump illumination, and accordingly, non-acoustic transient signals are produced and measured at locations 640, 650, and 660. The measurement of the non-acoustic transient signals at locations 640, 650, and 660 may occur sequentially, e.g., during a lateral scan of the sample, or may occur in parallel, e.g., using the detector with a multi-pixel array.

At locations 640, 650, and 660, illumination from the pulses in the pump beams 642, 652, and 662 are illustrated as the normally incident solid arrows. The pump beam 642, 652, and 662 may be a combination of the primary pump beam and secondary pump beam, as discussed above. The pump beams 642, 652, and 662 may use infrared wavelengths, that penetrate the silicon substrate 622 without significant absorption. The SiO₂ layers 624 and 634 are not strongly absorbing material and do not produce transient expansions in response to the pulses in the pump beams 642, 652, and 662, and thus no (or very little) acoustic signals are generated in the SiO₂ layers 624 and 634. The pump beams 642, 652, and 662, however, produce non-acoustic transient perturbations, e.g., due to the absorption of the pulses from the pump beams via multi-photon ionization or due to distortion of the sample material properties at the interface. Non-acoustic transient perturbations 644, 654, and 664 are produced in response to the primary pump beam at locations 640, 650, and 660, respectively, as illustrated by outwardly radiating solid arrows and non-acoustic transient perturbations 645, 655, and 665 are produced in response to the secondary pump beam at locations 640, 650, and 660, respectively, as illustrated by outwardly radiating dotted arrows. The non-acoustic transient perturbations 644/645, 654/655, and 664/665 are produced in response to the primary pump pulses and secondary pump pulses in the pump beams 642, 652, and 662, respectively, and are generated by non-acoustic physical phenomena, such as one or more of thermal dissipation, electron-hole recombination, plasma diffusion, symmetry breaking at top and bottom oxide surfaces, etalon effects within the void 602, etc. Unlike the acoustic transient perturbations illustrated in FIG. 5A, the non-acoustic transient perturbations 644/645, 654/655, and 664/665 are not reflected and returned by structures, but instead are produced in response to, e.g., absorption of the pulses from the pump beams, and decay over time. The presence of structures, such as void 602, affect the rate of decay of the non-acoustic transient perturbations 644/645, 654/655, and 664/665.

The reflectance at locations 640, 650, and 660 is measured by pulses in the probe beams 643, 653, and 663, which are illustrated as being incident on and reflected by the sample 600 at a non-normal angle of incidence. It should be understood, however, that the probe beams 643, 653, and 663 may be co-linear with pump beams 642, 652, and 662, or if desired, the pump beams 642, 652, and 662 may be incident on the sample 600 at a non-normal angle of incidence and the probe beams 643, 653, and 663 may be incident on and reflected by the sample 600 at a normal angle of incidence. The reflectance of the sample, e.g., at the interface of the SiO₂ layers 624 and the silicon substrate 622 as measured by probe beams 643, 653, and 663 at locations 640, 650, and 660 is modulated due to changes in reflectivity of the SiO₂ layers 624 caused by the non-acoustic transient perturbations 644, 654, and 664. In some situations, the reflectance of the sample may also or alternatively be due to changes in surface deformation. The non-acoustic transient perturbations 644/645, 654/655, and 664/665 decay over time and, accordingly, the measured reflectance produced in response to the non-acoustic transient perturbations 644/645, 654/655, and 664/665 will likewise change over time. In general, for measurements of acoustic transient signals, as illustrated in FIG. 5A, the non-acoustic transient perturbations 644/645, 654/655, and 664/665 would be considered background signals and would be removed from the raw transient signal measurements. In the present implementation, however, there is no or little acoustic information, and accordingly, the raw transient signals measured and analyzed for locations 640, 650, and 660 is the non-acoustic transient perturbations 644/645, 654/655, and 664/665.

As discussed above, the pump beams 642, 652, 662 are a combination of the primary pump beam and the secondary pump beam. The pulses in the pump beams 642, 652, 662 have fixed time delays between the primary pump beam and the secondary pump beam. The pulses in the probe beams 643, 653, 663 may have a fixed delay with respect to the pulses in the pump beams 642, 652, and 662, in which case there is a first fixed time delay with respect to a corresponding pulse in the primary pump beam and a second fixed time delay with respect to a corresponding pulse in the secondary pump beam. The non-acoustic transient perturbations 644/645, 654/655, and 664/665 produced in response to the primary pump pulses and the secondary pump pulses will be returned to the surface of the metallic layer 624, i.e., the interface between metallic layer 624 and the silicon substrate 622, when a pulse from the probe beams 643, 653, and 663 are incident on the surface of the metallic layer 624. The non-acoustic transient perturbations 644/645, 654/655, and 664/665 decay over time, and thus, the non-acoustic transient perturbations 644, 654, and 664 produced in response to the primary pump pulses will be more decayed than the non-acoustic transient perturbations 645, 655, and 665 produced by the secondary pump pulses, when measured by pulses from the probe beams 643, 653, 663. Accordingly, at location 640, the pulses in the probe beam 643 will be modulated due to changes in reflectance caused by the combination of non-acoustic transient perturbations 644 and 645. Similarly, at location 660, the pulses in the probe beams 663 will be modulated due to changes in reflectance caused by non-acoustic transient perturbations 664 and 665. At location 650, the probe beam 653 will be modulated due to changes in reflectance caused by non-acoustic transient perturbations 654 and 655, which differ from non-acoustic transient perturbations 644/645 and 664/665 due to the presence of the void 602.

In some implementations, the measurements at each location 640, 650, and 660 may be performed using a variable pump-probe delay, so that pulse in the probe beams 643, 653, 663 have variable delay with respect to the pulses in the pump beams 642, 652, and 662, and the first time delay with respect to a corresponding pulse in the primary pump beam and a second time delay with respect to a corresponding pulse in the secondary pump beam varies, but is offset by the fixed delay between the primary pump beam and secondary pump beam.

By demodulating the probe beams 643, 653, and 663, the instantaneous signal difference produced in response to the fixed time delay between the primary pump pulses and secondary pump pulses may be determined.

FIG. 6B illustrates an example graph of the non-acoustic transient signals 646, 656, and 666 detected by probe beams 643, 653, and 663 at locations 640, 650, and 660, respectively, in FIG. 6A. In the graph of FIG. 6B, the X axis represents the delay time between the pump and probe beams in picoseconds (ps), and the Y axis represents the differential reflectance in arbitrary units (AU). The measured non-acoustic transient signals 646, 656, 666 are in response to non-acoustic perturbations produced at locations 640, 650 and 660 in response to a single pump beam, e.g., a pump beam that does not include the secondary pump beam, and that has a pump-probe delay time that varies from 1000 ps to approximately 3000 ps. The presence of the void 602 at location 650, however, results in a difference in the non-acoustic perturbation 654 with respect to the non-acoustic transient perturbations 644 and 664 at locations 640 and 660, and accordingly, the resulting measured non-acoustic transient signals produced in response to these perturbations will likewise differ. As illustrated in FIG. 6B, the non-acoustic transient signals 646 and 666 from locations 640 and 660, where no void is present, are generally similar in attributes or traits such as the shape or slope of the transient signals. In contrast, the non-acoustic transient signals 656 from location 650, where the void 602 is present, is dissimilar as to these attributes or traits, such as the shape or slope to the non-acoustic transient signals 646 and 666 at locations 640 and 660 on the sample 600. Accordingly, analysis of the transient signals may be performed to differentiate between various attributes or traits of the transient signals from different locations. The attributes or traits of the transient signals from different locations may be used to determine whether the measurements are carried out at locations with voids or locations without voids.

If measurements are produced using a variable delay time between the pump pulses and the probe pulses, curves such as illustrated by 646, 656, and 666 over the range of delay times may be generated and may be analyzed, e.g., based on polynomial or other curve fits, such as exponential, of the transient signals at the different locations or other types of analysis, such as principal component analysis (PCA), or a comparison of the attributes or traits, such as the shape, slope, rate of change, etc.

While the presence of the void or lack of void was determined based on a difference in the transient signals at a specific time delay, e.g., a single point on the time delay axis, if the transient signals are produced by acoustic perturbations, as discussed in FIG. 6B, when the transient signals are produced by non-acoustic perturbations, such as one or more of thermal dissipation, electron-hole recombination, plasma diffusion, symmetry breaking at top and bottom oxide surfaces, etalon effects, etc., the presence of the void or lack of void is determined based on the difference in the transients signals over a range of time delays, e.g., a plurality of points on the time delay axis. For example, the number of time delays used to analyze the transient signals may be dependent on the sample under test, but should be adequate to identify one or more features of the non-acoustic transient signals, such as the shape, slope, rate of change, etc., that characterizes desired attributes or traits, such as the rate of decay of the non-acoustic transient perturbations, from which the presence of a buried structure, such as a void, may be determined.

As discussed above, the pump beams 642, 652, and 662 are a combination of the primary pump beam and the secondary pump beam. By a judicious selection of the fixed time delay between the pulses in the primary pump beam and the pulses in the secondary pump beam the sensitivity of the resulting instantaneous signal difference may be optimized. For example, the fixed time delay D between the pulses in the primary pump beam and the pulses in the secondary pump beam is illustrated as the distance between the first delay between the primary pump pulses and the probe pulses, e.g., delay d1 shown in FIG. 6B, and the second delay between the secondary pump pulses and the probe pulses, e.g., delay d2 shown in FIG. 6B. The instantaneous signal difference produced non-acoustic transient signal 656 will significantly differ from the instantaneous signal difference produced by acoustic transient signal 646 and 666 due to the presence of the void 602, and thus based on the instantaneous signal difference, the presence of the void 602 may be determined. As discussed above, the pump-probe delay may vary during the measurements, and multiple instantaneous signal differences resulting from the fixed time delay D at different pump-probe delays will be produced, e.g., the fixed time delay D is scanned across the X axis in FIG. 6B. In another implementation, the pump-probe delay may be fixed during the measurements, e.g., at the one position of the fixed time delay D on the X axis illustrated in FIG. 6B, and the measurement location scanned over the sample.

In some implementations, fixed time delay D between the pulses in the primary pump beam and the pulses in the secondary pump beam may be altered to adjust one or both of the first delay d1 and second delay d2, e.g., by altering one or both of the probe beam paths to increase sensitivity to the instantaneous signal difference. As can be seen in FIG. 6B, the resulting difference in the signals produced in response to the first time delay d1 and the second time delay d2 will be different for the non-acoustic transient signals 646 and 666 from locations 640 and 660, where no void is present, and the non-acoustic transient signals 656 from locations 650, where the void 602 is present. For example, FIG. 6B illustrates the signal difference in the non-acoustic transient signals 656 from location 650 at the first time delay d1 and the second time delay d2 as approximately 0, while the signal difference in the non-acoustic transient signals 646 and 666 from locations 640 and 660 at the first time delay d1 and the second time delay d2 will be non-zero. Thus, the void 602 may be detected using instantaneous signal differencing using a fixed time delay between the primary pump beam and secondary pump beam. Moreover, an image of the sample 600, including the presence of the void 602, may be generated based on the instantaneous signal differencing of non-acoustic transient signals from the multiple locations, e.g., by laterally scanning the measurement location over the sample.

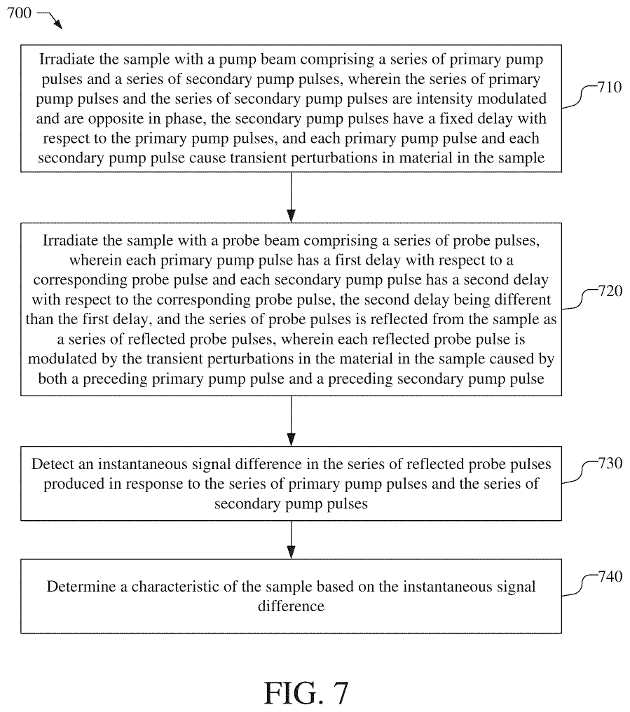

FIG. 7 is a flow chart 700 illustrating a method of non-destructively characterizing a sample using an instantaneous signal difference that is a difference between signals produced by different delay times from multiple pump beams acquired with a single probe beam, as discussed herein. The process, for example, may be performed using time resolved reflectance metrology devices 100 or 200 shown in FIG. 1 or 2, respectively.

As illustrated, at block 710, the process includes irradiating the sample with a pump beam including a series of primary pump pulses and a series of secondary pump pulses, where the series of primary pump pulses and the series of secondary pump pulses are intensity modulated and are opposite in phase, the secondary pump pulses have a fixed delay with respect to the primary pump pulses, and each primary pump pulse and each secondary pump pulse cause transient perturbations in material in the sample, e.g., as illustrated by the pump arms 120 and 210 in metrology devices 100 and 200 in FIGS. 1 and 2, respectively, and discussed in reference to FIGS. 4, 5A and 6A.

At block 720, the sample is irradiated with a probe beam including a series of probe pulses, where each probe pulse has a first delay with respect to a preceding primary pump pulse and a second delay with respect to a preceding secondary pump pulse, the second delay being different than the first delay, and the series of probe pulses is reflected from the sample as a series of reflected probe pulses, where each reflected probe pulse is modulated by the transient perturbations in the material in the sample caused by both the preceding primary pump pulse and the preceding secondary pump pulse, e.g., as illustrated by the probe arms 130 and 220 in metrology devices 100 and 200 in FIGS. 1 and 2, respectively, and discussed in reference to FIGS. 4, 5A and 6A. In some implementations, the first delay and the second delay are fixed delays. In some implementations, the probe pulses have a variable delay with respect to the primary pump pulses and the secondary pump pulses.

At block 730, an instantaneous signal difference is detected in the series of reflected probe pulses produced in response to the series of primary pump pulses and the series of secondary pump pulses, e.g., as illustrated by the detectors 160 and 228 in metrology devices 100 and 200 in FIGS. 1 and 2, respectively, and discussed in reference to FIGS. 4, 5B and 6B.

At block 740, a characteristic of the sample is determined based on the instantaneous signal difference, e.g., as illustrated by the processing systems 170 and 230 in metrology devices 100 and 200 in FIGS. 1 and 2, respectively, and discussed in reference to FIGS. 5A and 6A. In some implementations, the characteristic of the sample is a presence or absence of a buried structure in the sample, e.g., as discussed in relation to FIGS. 5A and 5B. In some implementations, the characteristic of the sample is a presence or absence of a void in the material of the sample that is transparent to the pump beam, e.g., as discussed in relation to FIGS. 6A and 6B.

In some implementations, for example, irradiating the sample with the pump beam may include generating a series of pump pulses of light and modulating an intensity of the series of pump pulses of light, e.g., as illustrated by the light sources 102 and 211, and optical modulators 122 and 212 in metrology devices 100 and 200 in FIGS. 1 and 2, respectively, and discussed in FIGS. 3 and 4. Each pump pulse in the series of pump pulses may be split into a primary pump pulse and a secondary pump pulse to produce the series of primary pump pulses and the series of secondary pump pulses that are intensity modulated and are opposite in phase, e.g., as illustrated by the beam splitters 124 and 213 in metrology devices 100 and 200 in FIGS. 1 and 2, respectively, and discussed in FIGS. 3 and 4. Additionally, a difference in a primary pump path length for the series of primary pump pulses with respect to a secondary pump path length for the series of secondary pump pulses is generated to produce the fixed delay between the primary pump pulses and the secondary pump pulses, e.g., as illustrated by the primary and secondary beam paths 125/126 and 214/215 in metrology devices 100 and 200 in FIGS. 1 and 2, respectively, and discussed in FIGS. 3 and 4.

In some implementations, the process may further include generating a series of light pulses with a light source, and splitting the series of light pulses with a beam splitter into the pump beam and the probe beam, e.g., as illustrated by the light source 102 and beam splitter 106 in metrology device 100 in FIG. 1.

In some implementations, the process may further include generating the pump beam with a first light source and generating the probe beam with a second light source, e.g., as illustrated by the light sources 211 and 221 in metrology device 200 in FIG. 2.

The sample may be irradiated with the probe beam at a measurement location, and the process may further include maintaining the first delay and the second delay as fixed delays while laterally scanning the measurement location over the sample, e.g., as discussed in relation to metrology devices 100 and 200 in FIGS. 1 and 2, and in FIGS. 5A and 6A.

The process may further include adjusting the fixed delay between the primary pump pulses and the secondary pump pulses while irradiating the sample with the pump beam and irradiating the sample with a probe beam and detecting an instantaneous signal difference with a different fixed delay between the primary pump pulses and the secondary pump pulses to determine the characteristic of the sample, e.g., as discussed in relation to metrology devices 100 and 200 in FIGS. 1 and 2, and in FIGS. 5A and 6A. For example, adjusting the fixed delay between the primary pump pulses and the secondary pump pulses may include varying a difference in a primary pump path length for the series of primary pump pulses with respect to a secondary pump path length for the series of secondary pump pulses, e.g., as discussed in relation to the primary and secondary beam paths 125/126 and 214/215 in metrology devices 100 and 200 in FIGS. 1 and 2, respectively, and discussed in FIGS. 3 and 4.

In some implementations, the instantaneous signal difference may be detected in the series of reflected probe pulses by detecting the series of reflected probe pulses from the sample, and demodulating the series of reflected probe pulses to determine the instantaneous signal difference produced in response to the series of primary pump pulses and the series of secondary pump pulses, e.g., as illustrated by the detectors 160 and 228 and demodulators 162 and 229 in metrology devices 100 and 200 in FIGS. 1 and 2, respectively, and in FIGS. 4, 5B and 6B. The demodulating of the series of reflected probe pulses to determine the instantaneous signal difference may be based on a frequency of intensity modulation of the series of primary pump pulses and the series of secondary pump pulses, e.g., as discussed in relation to the detectors 160 and 228 and demodulators 162 and 229 in metrology devices 100 and 200 in FIGS. 1 and 2, respectively.

In some implementations, the transient perturbations in the material caused by each primary pump pulse and each secondary pump pulse are acoustic transient perturbations, e.g., as discussed in relation to FIGS. 5A and 5B. In some implementations, the transient perturbations in the material caused by each primary pump pulse and each secondary pump pulse are non-acoustic transient perturbations, e.g., as discussed in relation to FIGS. 6A and 6B. The non-acoustic transient perturbations, for example, may be produced by one or more of thermal dissipation, electron-hole recombination (e.g., probably generated in Si), plasma diffusion, symmetry breaking at top and bottom oxide surfaces, and an etalon effect.

The above description is intended to be illustrative, and not restrictive. For example, the above-described examples (or one or more aspects thereof) may be used in combination with each other. Other implementations can be used, such as by one of ordinary skill in the art upon reviewing the above description. Also, in the above Description, various features may be grouped together to streamline the disclosure. The inventive subject matter may lie in less than all features of a particular disclosed implementation. Thus, the following aspects are hereby incorporated into the Description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A method for non-destructively characterizing a sample using an instantaneous signal difference that is a difference between signals produced by different delay times from multiple pump beams acquired with a single probe beam, comprising:
irradiating the sample with a pump beam comprising a series of primary pump pulses and a series of secondary pump pulses, wherein the series of primary pump pulses and the series of secondary pump pulses are intensity modulated and are opposite in phase, the secondary pump pulses have a fixed delay with respect to the primary pump pulses, and each primary pump pulse and each secondary pump pulse cause transient perturbations in material in the sample;
irradiating the sample with a probe beam comprising a series of probe pulses, wherein each probe pulse has a first delay with respect to a preceding primary pump pulse and a second delay with respect to a preceding secondary pump pulse, the second delay being different than the first delay, and the series of probe pulses is reflected from the sample as a series of reflected probe pulses, wherein each reflected probe pulse is modulated by the transient perturbations in the material in the sample caused by both the preceding primary pump pulse and the preceding secondary pump pulse;
detecting an instantaneous signal difference in the series of reflected probe pulses produced in response to the series of primary pump pulses and the series of secondary pump pulses; and
determining a characteristic of the sample based on the instantaneous signal difference.

2. The method of claim 1, wherein the first delay and the second delay are fixed delays.

3. The method of claim 1, wherein the probe pulses have a variable delay with respect to the primary pump pulses and the secondary pump pulses.

4. The method of claim 1, wherein irradiating the sample with the pump beam comprising the series of primary pump pulses and the series of secondary pump pulses comprises:
generating a series of pump pulses of light;
modulating an intensity of the series of pump pulses of light;
splitting each pump pulse in the series of pump pulses into a primary pump pulse and a secondary pump pulse to produce the series of primary pump pulses and the series of secondary pump pulses that are intensity modulated and are opposite in phase; and
generating a difference in a primary pump path length for the series of primary pump pulses with respect to a secondary pump path length for the series of secondary pump pulses to produce the fixed delay between the primary pump pulses and the secondary pump pulses.

5. The method of claim 1, further comprising:
generating a series of light pulses with a light source; and
splitting the series of light pulses with a beam splitter into the pump beam and the probe beam.

6. The method of claim 1, further comprising:
generating the pump beam with a first light source; and
generating the probe beam with a second light source.

7. The method of claim 1, wherein the sample is irradiated with the probe beam at a measurement location, the method further comprising maintaining the first delay and the second delay as fixed delays while laterally scanning the measurement location over the sample.

8. The method of claim 1, further comprising adjusting the fixed delay between the primary pump pulses and the secondary pump pulses while irradiating the sample with the pump beam and irradiating the sample with a probe beam and detecting an instantaneous signal difference with a different fixed delay between the primary pump pulses and the secondary pump pulses to determine the characteristic of the sample.

9. The method of claim 8, wherein adjusting the fixed delay between the primary pump pulses and the secondary pump pulses comprises varying a difference in a primary pump path length for the series of primary pump pulses with respect to a secondary pump path length for the series of secondary pump pulses.

10. The method of claim 1, wherein detecting the instantaneous signal difference in the series of reflected probe pulses produced in response to the series of primary pump pulses and the series of secondary pump pulses comprises:
detecting the series of reflected probe pulses from the sample; and
demodulating the series of reflected probe pulses to determine the instantaneous signal difference produced in response to the series of primary pump pulses and the series of secondary pump pulses, wherein demodulating the series of reflected probe pulses to determine the instantaneous signal difference is based on a frequency of intensity modulation of the series of primary pump pulses and the series of secondary pump pulses.

11. The method of claim 1, wherein the transient perturbations in the material caused by each primary pump pulse and each secondary pump pulse are acoustic transient perturbations or non-acoustic transient perturbations produced by one or more of thermal dissipation, electron-hole recombination, plasma diffusion, symmetry breaking at top and bottom oxide surfaces, and an etalon effect.

12. The method of claim 1, wherein the characteristic of the sample is a presence or absence of a buried structure in the sample or a void in the material of the sample that is transparent to the pump beam.

13. A metrology device for non-destructively characterizing a sample using an instantaneous signal difference that is a difference between signals produced by different delay times from multiple pump beams acquired with a single probe beam, comprising:
a pump arm that irradiates the sample with a pump beam comprising a series of primary pump pulses and a series of secondary pump pulses, wherein the series of primary pump pulses and the series of secondary pump pulses are intensity modulated and are opposite in phase, the secondary pump pulses have a fixed delay with respect to the primary pump pulses, and each primary pump pulse and each secondary pump pulse cause transient perturbations in material in the sample;
a probe arm that irradiates the sample with a probe beam comprising a series of probe pulses, wherein each probe pulse has a first delay with respect to a preceding primary pump pulse and a second delay with respect to a preceding secondary pump pulse, the second delay being different than the first delay, and the series of probe pulses is reflected from the sample as a series of reflected probe pulses, wherein each reflected probe pulse is modulated by the transient perturbations in the material in the sample caused by both the preceding primary pump pulse and the preceding secondary pump pulse;
a detector that detects the series of reflected probe pulses to determine an instantaneous signal difference in the series of reflected probe pulses produced in response to the series of primary pump pulses and the series of secondary pump pulses; and
at least one processor coupled to the detector and is configured to determine a characteristic of the sample based on the instantaneous signal difference.

14. The metrology device of claim 13, wherein the first delay and the second delay are fixed delays.

15. The metrology device of claim 13, wherein the probe pulses have a variable delay with respect to the primary pump pulses and the secondary pump pulses.

16. The metrology device of claim 13, wherein the pump arm comprises:
an optical modulator that modulates an intensity of a series of pump pulses of light;
a beam splitter that splits each pump pulse in the series of pump pulses into a primary pump pulse that is directed along a primary pump path and a secondary pump pulse that is directed along a secondary pump path to produce the series of primary pump pulses and the series of secondary pump pulses that are intensity modulated and are opposite in phase, wherein a primary pump path length and a secondary pump path length are different to produce the fixed delay between the primary pump pulses and the secondary pump pulses; and
a beam combiner that combines the series of primary pump pulses and the series of secondary pump pulses into the pump beam.

17. The metrology device of claim 13, further comprising:
a light source that generates a series of light pulses; and
a beam splitter that splits the series of light pulses into the pump beam and the probe beam.

18. The metrology device of claim 13, further comprising:
a first light source that generates the pump beam; and
a second light source that generates the probe beam.

19. The metrology device of claim 13, further comprising an actuator to produce relative lateral motion between the sample and the pump and probe arms to laterally scan a measurement location over the sample, wherein the first delay and the second delay as fixed delays are maintained while laterally scanning the measurement location over the sample.

20. The metrology device of claim 13, further comprising a variable delay to adjust the fixed delay between the primary pump pulses and the secondary pump pulses while irradiating the sample with the pump beam and the detector detects an instantaneous signal difference with a different fixed delay between the primary pump pulses and the secondary pump pulses and irradiating the sample with a probe beam to determine the characteristic of the sample.

21. The metrology device of claim 20, wherein the variable delay varies a difference in a primary pump path length for the series of primary pump pulses with respect to a secondary pump path length for the series of secondary pump pulses.

22. The metrology device of claim 13, further comprising a demodulator coupled to the detector to demodulate the series of reflected probe pulses to determine the instantaneous signal difference produced in response to the series of primary pump pulses and the series of secondary pump pulses and the demodulator demodulates the series of reflected probe pulses to determine the instantaneous signal difference based on a frequency of intensity modulation of the series of primary pump pulses and the series of secondary pump pulses.

23. The metrology device of claim 13, wherein the transient perturbations in the material caused by each primary pump pulse and each secondary pump pulse are acoustic transient perturbations or non-acoustic transient perturbations produced by one or more of thermal dissipation, electron-hole recombination, plasma diffusion, symmetry breaking at top and bottom oxide surfaces, and an etalon effect.

24. The metrology device of claim 13, wherein the characteristic of the sample is a presence or absence of a buried structure in the sample a void in the material of the sample that is transparent to the pump beam.
